(19) United States
(12) Patent Application Publication
(10) Pub. No.: US 2025/0116517 A1
(43) Pub. Date: Apr. 10, 2025

(54) APPARATUS AND METHOD FOR QUADRATURE REDUCTION IN VIBRATORY GYROSCOPES

(71) Applicant: Panasonic Intellectual Property Management Co., Ltd., Osaka (JP)

(72) Inventors: Amir RAHAFROOZ, Shaker Heights, OH (US); Diego EMILIO SERRANO, Alpharetta, GA (US); Ijaz JAFRI, Holliston, MA (US)

(21) Appl. No.: 18/482,403

(22) Filed: Oct. 6, 2023

(51) Int. Cl. G01C 19/5677

(52) U.S. Cl. CPC G01C 19/5677

(57) ABSTRACT

A gyroscope includes a vibratory plate with at least one notch, wherein each notch is a positive notch that is a formed by adding a mass to the vibratory plate, or a negative notch that is formed by removing a mass from the vibratory plate, and an anchor configured to support the vibratory plate. Across the wafer, a gyro design with a few different notch sizes can be designed to counteract the quadrature pattern. Depending on the type and magnitude of imperfection, a notch size and its location can be determined. The locations to add or remove a mass on the disk may be identified as follows. The locations where one gyro mode has a larger displacement while the second gyro mode has no displacement or a smaller displacement can be used to substantially impact the frequency of one of the first resonance mode or the second resonance mode. Alternatively, the locations where both gyro modes have the substantially same displacement amplitude can be used to impact the coupling between the two modes.

### TECHNICAL FIELD

The present disclosure relates to apparatuses and methods for reducing quadrature in gyroscopes. The gyroscopes reduce the quadrature significantly by adding positive or negative notches to a vibratory disk.

### BACKGROUND

Vibratory gyroscope uses Coriolis effect to detect and measure rate of rotation. A vibratory gyroscope includes a vibrating structure capable of vibration in two resonance modes. The first resonance mode is set into oscillation. During rotation part of the energy propositional to the applied rate moves from the vibrating mode to the second mode. The rate of rotation can be measured by detecting the vibration in the second mode. Quadrature in vibratory gyroscopes may refer to a non-zero output when no rate of rotation is applied. Quadrature error is mainly caused due to having misaligned resonance modes or in other words due to having a residual coupling between the two resonance modes.

Quadrature is undesired as it translates into having a non-zero value at the output when no rate is applied. Also, this quadrature error results in up-conversion of flicker noise from circuitry and can limit bias instability. Further, the quadrature can also saturate the gain stages on ASIC and impact performance. Quadrature can be caused by various factors such as microfabrication process variations, thermal effects and mechanical stress.

Previously known techniques for quadrature reduction primarily focused on mitigating the significant quadrature error that occurs after the devices are already fabricated, typically through the utilization of electrostatic forces in electrostatic gyroscopes or by adjusting the placement of drive and sense electrodes in the case of piezoelectric gyroscopes. However, these approaches have limitations on the maximum quadrature level that can be compensated.

Another option is laser trimming, which is a time-consuming and potentially iterative process that needs to be performed individually for each gyroscope. Thus, the embodiments according to the present disclosure can be applied before fabrication and can help other methods.

Gyroscopes have several mechanisms to compensate for the quadrature. As an example, in electrostatic gyroscopes the issue is often addressed in the form of applying electrostatic forces in specific locations. Due to the nonlinear nature of electrostatic force, it would have a component proportional to the displacement impacting the stiffness coupling between the two modes. However, the electrostatic gyroscopes have limitations in that the maximum DC voltage provided by the charge-pump would dictate the maximum quadrature that can be compensated.

As another example, in Piezoelectric gyroscopes the compensation can be done by adjusting the location of excitation and pick off electrodes. However, this mechanism has limitations in that some residual quadrature remains.

These mechanisms can be in the form of laser trimming of the gyroscopes. However, this laser trimming also has limitations of being iterative and time consuming. Also, both electrostatic and piezoelectric gyroscopes have limits on how big of a quadrature they can compensate. The above-mentioned methods each would have their own limits and any large quadrature induced due to fabrication process variations would be best to be addressed beforehand. In other words, fabrication imperfections can impact, mode-to-mode coupling k₁₂/k₂₁ and stiffness/mass of each mode k₁/k₂. In short, process variations can create large quadrature levels with known patterns across wafers that degrade gyro performance and/or impact overall yield.

### BRIEF SUMMARY

To address the above problems, the present disclosure provides the solution that by adding and/or removing a mass (referred to as notches) to/from the disk, the quadrature can be significantly reduced. Across a wafer, the same gyro design but with a few different notch sizes can be designed to counteract the quadrature pattern. Depending on the type and magnitude of imperfection, a notch size and its location can be determined.

The locations to add or remove a mass on a wafer may be identified as follows. The locations where one gyro mode has a larger displacement while the second gyro mode has no displacement or a smaller displacement can be used to substantially impact the frequency of one of the first resonance mode or the second resonance mode. Alternatively, the locations where both gyro modes have the substantially same displacement amplitude can be used to impact the coupling between the two modes.

These solutions may work for wine-glass/elliptical disk/ring gyroscopes and similarly hemispherical resonator gyroscopes (HRGs) and disk resonator gyroscopes (DRGs) but can be used for other types of gyroscopes as well.

In one aspect, a gyroscope includes a vibratory plate with at least one notch, wherein each notch is a positive notch that is a formed by adding a mass to the vibratory plate, or a negative notch that is formed by removing a mass from the vibratory plate, and an anchor configured to support the vibratory plate.

At least one notch may be formed on an outer periphery of the vibratory plate.

At least one notch may comprise two positive notches located in opposite sides of the vibratory plate.

At least one notch may comprise two negative notches located in opposite sides of the vibratory plate.

At least one notch may comprise two positive notches located in opposite sides of the vibratory plate, and two negative notches located in opposite sides of the vibratory plate.

Each location of the at least one notch may be identified so as to substantially impact a stiffness of one of the first resonance mode or the second resonance mode.

Each location of the at least one notch may be determined at a position that has a larger displacement in one resonance mode and that has a smaller displacement in another resonance mode.

Each location of the at least one notch may be determined at a position that has a substantially maximum displacement in a first resonance mode and that has a substantially zero displacement in a second resonance mode.

A resonance frequency of the first mode increases, while a resonance frequency of the second resonance mode remains relatively unaffected compared to the increased resonance frequency of the second mode.

Each location of the at least one notch may be determined at a position that has a substantially zero displacement in a first resonance mode and that has the substantially maximum displacement in the second resonance mode.

A resonance frequency of the second mode decreases, while a resonance frequency of the first resonance mode remains relatively unaffected compared to the decreased resonance frequency of the second mode.

At least one notch may comprise two positive notches, wherein a first positive notch may be located at a position with a substantially maximum displacement in the first resonance mode, and a second positive notch may be located at a position with a substantially maximum displacement in the second resonance mode, wherein the first and second notches are in opposite sides of the vibratory plate.

At least one notch may comprise two negative notches, wherein a first negative notch may be located at a position with a substantially maximum displacement in the first resonance mode, and a second negative notch may be located at a position with a substantially maximum displacement in the second resonance mode, wherein the first and second negative notches are in opposite sides of the vibratory plate.

At least one notch may comprise two positive notches and two negative notches, wherein the two positive notches are located in opposite sides at respective positions with a substantially maximum displacement in the first resonance mode, and the two negative notches are located in opposite sides at respective positions with a substantially maximum displacement in the second resonance mode.

Each location of the at least one notch may be identified so as to impact a stiffness coupling between the first resonance mode and a second resonance mode.

Each location of the at least one notch may be determined at a position that has a substantially same displacement in the first and second resonance modes.

A stiffness coupling between the first and second resonance mode increases or decreases, depending on an angle of the position.

At least one notch may comprise two positive notches, wherein a first positive notch may be located at a position with the substantially same displacement in the first and second resonance modes, and a second positive notch may be located at a position with the substantially same displacement in the first and second resonance modes, wherein the first and second positive notches are in opposite sides of the vibratory plate.

At least one notch may comprise two negative notches, wherein a first negative notch may be located at a position with the substantially same displacement in the first and second resonance modes, and a second negative notch may be located at a position with the substantially same displacement in the first and second resonance modes, wherein the first and second negative notches are in opposite sides of the vibratory plate.

At least one notch may comprise two positive notches and two negative notches, wherein the two positive notches are located in opposite sides at respective positions with the substantially same displacement in the first and second resonance modes, and two negative notches are located in opposite sides at respective positions with the substantially same displacement in the first and second resonance modes.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, coupled to or with, be communicable with, cooperate with, interleave, juxtapose, be proximate to, be bound to or with, have, have a property of, or the like. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

FIGS. 1A to 1C illustrate the schematic diagrams of a vibratory gyroscope (gyro) operating in the wine-glass modes and its radial displacements, according to one embodiment of the present disclosure.

FIG. 2A to 2C illustrates the superimposed SED profile that is a combination of the SED profile of Mode 1 and SED profile of Mode 2.

FIG. 3A to 3D illustrate various strain energy density (SED) profiles of disks for the two third order wine-glass modes.

FIG. 4A to 4C are the diagrams to show notch locations which impact the stiffness/mass of one mode, according to one embodiment of the disclosure.

FIGS. 5A to 5D illustrate three examples of how to determine notch locations to impact the resonance frequencies of the disk according to one embodiment of the present disclosure.

FIG. 6A to 6C show the diagrams to show how the notch locations impact stiffness couplings between the two modes according to another embodiment of the disclosure.

FIGS. 7A to 7D illustrate three examples of how to determine notch locations to impact stiffness couplings of the two modes according to one embedment of the present disclosure.

FIGS. 8A to 8F illustrate several examples on various shapes and arrangements of notches designed to impact the resonance frequencies according to one embedment of the present disclosure.

FIG. 9 illustrates the plots representing the electrostatic voltage (here called V_{Q}) pattern used to cancel quadrature across a wafer (or a disk) according to one embedment of the present disclosure.

FIG. 10 illustrates the stiffness coupling pattern that is converted from the electrostatic voltage V_{Q} of FIG. 9 according to one embedment of the present disclosure.

FIGS. 11A and 11B illustrate the experimental finite element analysis (FEA) results of k₁₂ values vs. notch sizes according to one embedment of the present disclosure.

FIG. 12A illustrates the baseline gyro design with no notch, FIG. 12B illustrates notched gyro design 1, FIG. 12C illustrates notched gyro design 2, and FIG. 12D illustrates the combined gyro designs, according to one embodiment of the present disclosure instanced across wafer

FIG. 13A illustrates the experimental effective electrostatic voltage V_{Q} of a baseline design, and FIG. 13B illustrates the effective electrostatic voltage V_{Q} of the combined three designs. FIG. 13C illustrates the histogram distribution comparison of V_{Q} between the baseline design and the combined three designs.

Throughout the drawings, it should be noted that like reference numbers are used to depict the same or similar elements, features, and structures.

### DETAIL DESCRIPTION

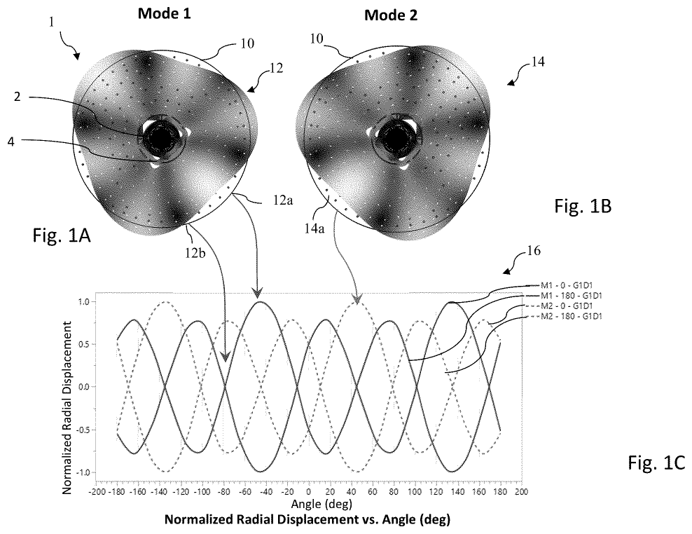

FIGS. 1A to 1C illustrate the schematic diagrams of a vibratory gyroscope operating in the wine-glass modes and its radial displacements, according to one embodiment of the present disclosure. Gyroscope 1 may comprise disk 10 which is connected to central anchor 2 through decoupling structure 4.

FIG. 1A illustrates resonance profile 12 of disk 10 operating in Mode 1 of the degenerate 3^{rd} order wine-glass resonance, and FIG. 1B illustrates resonance profile 14 of the same disk operating in Mode 2. The regions in the white and black colors represent areas with the maximum and minimum radial displacements, respectively.

FIG. 1C shows the plots 16 representing the normalized radial displacement envelopes for the two 3rd order wineglass modes across disk 10. The solid lines M1-0, M1-180 represent the normalized radial displacements with 180° degrees offset in the first mode (Mode 1) and the dashed lines M2-0, M2-180 represent the normalized radial displacements with 180° degrees offset in the second mode (Mode 2). Here, the positive radial displacements may represent the expanded portions of the disk in the resonance, and the negative radial displacements may represent the contracted portions of the disk in the resonance.

Gyroscope 1 may be modeled as the two coupled second order differential equations. Equations 1 and 2 below are the coupled second order differential equations that may be used to represent the gyro model:

$${\ddot{x}}_{1} + \frac{1}{{Q}_{1}} \sqrt{\frac{{k}_{1}}{{m}_{1}}} {\dot{x}}_{1} + \frac{{k}_{1}}{{m}_{1}} {x}_{1} + \frac{{k}_{12}}{{m}_{1}} {x}_{2} = \frac{{F}_{1}}{{m}_{1}} cos ( ω t ) - 2 λ {Ω}_{z} {\dot{x}}_{2} \qquad ( Equation 1 )$$

$${\ddot{x}}_{2} + \frac{1}{{Q}_{2}} \sqrt{\frac{{k}_{2}}{{m}_{2}}} {\dot{x}}_{2} + \frac{{k}_{2}}{{m}_{2}} {x}_{2} + \frac{{k}_{21}}{{m}_{2}} {x}_{1} = 2 λ {Ω}_{z} {\dot{x}}_{1} \qquad ( Equation 2 )$$

where x₁ and x₂ are the displacements of mode #1 & #2 respectively. k and m are the stiffness and mass. Q is the quality factor. F is the force applied to Mode 1 to drive into oscillation. A is the Coriolis coupling and Ω is the rate of rotation.

The present disclosure provides the embodiments of reducing the quadrature by adding or removing a mass to/from the gyroscope. Adding or removing a mass from the gyroscope can have the following impacts: (i) a change in quality factor (mainly supports loss, quality of thermo-elastic damping (Q_{TED})), (ii) a change in damping coupling, (iii), changes in stiffnesses of each mode (k₁/k₂), (iv) a change in a mass, and (v) changes in stiffness couplings between the two modes (k₁₂/k₂₁).

In this disclosure, the preferred locations for adding and removing a mass are presented to mainly introduce one of the following changes without impacting other parameters: a change in stiffnesses/mass of each mode, and/or a change in stiffness coupling between the two modes.

In one embodiment, the locations of notches may be identified so as to reduce the Impact of adding/removing a mass on the support loss and Q_{TED}.

Any mass manipulations would have a larger impact on TED and support loss if the mass manipulation occurs in the regions with larger strain energy density (SED). By superimposing an SED for mode 1 and an SED for mode 2, a superimposed profile can be used to find the preferred locations for the mass manipulations.

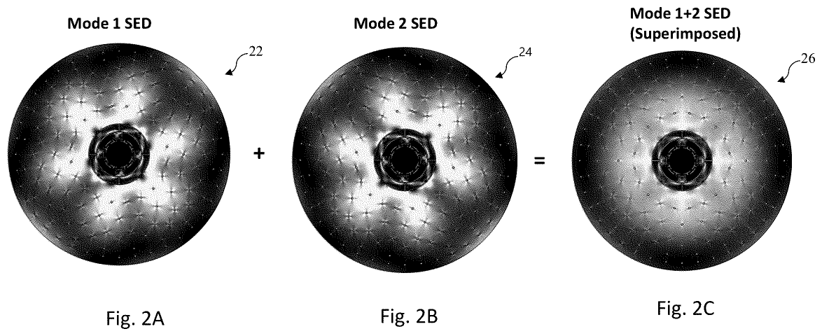

FIG. 2A to 2C illustrates the superimposed SED profile 26 that is a combination of the SED profile 22 of Mode 1 and SED profile 24 of Mode 2. The superimposed SED profile 26 for the two 3rd order wine-glass modes clearly shows that regions close to the inner periphery of the disk have a higher SED while areas closer to the outer periphery have a less SED.

In the superimposed SED profile 26, the mass addition and removal may be performed at the outer edge periphery of the disk to mainly impact stiffness/mass for each mode independently or the stiffness coupling between the two modes.

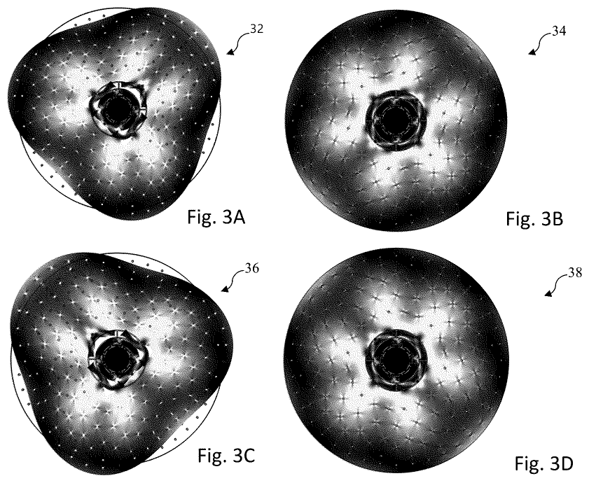

FIG. 3A to 3D illustrate various strain energy density (SED) profiles of disks.

FIG. 3A and FIG. 3B show the SEDs 32, 34 for the first mode (Mode 1). The difference between these two figures is that FIG. 3A shows the gyroscope deformation as well.

FIG. 3C and FIG. 3D show the SEDs 36, 38 for the second mode (Mode 2). The difference between these two figures is that FIG. 3C shows the gyro deformation as well.

The regions in white color have a maximum SED, and the regions in black color have a minimum SED. The regions in the gray gradation have medium SEDs proportional to the degree of their gradation.

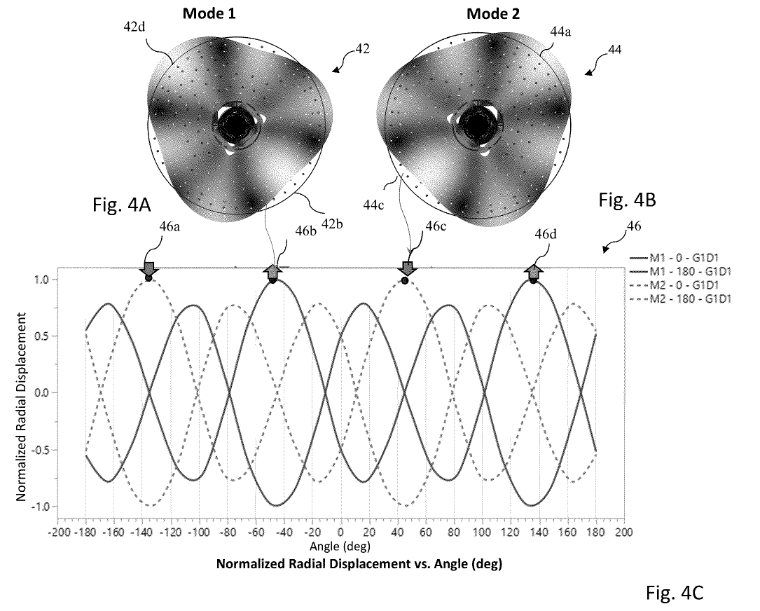

FIG. 4A to 4C are the diagrams to show notch locations which impact the stiffness/mass of one mode according to one embodiment of the disclosure.

The locations of notches may be identified so as to impact the stiffness/mass of one mode. In this embodiment, by adding or removing mass at areas where one mode has a substantially maximum radial displacement while the other mode has a substantially zero or minimum radial displacement, the stiffness/mass for one mode can be impacted while the other mode remains relatively unaffected or less affected compared to the other mode. Here the substantially maximum radial displacement refers to a displacement that differs by less than 10% from the maximum radial displacement when normalized. Also, the substantially minimum or zero radial displacement refers to a displacement that differs by less than 10% from the minimum or zero displacement when normalized.

As an example, upward arrows 46b, 46d indicate the maximum radial displacement in Mode 1, which correspond to the white regions 42b, 42d in FIG. 4A. Downward arrows 46a, 46c indicate the maximum radial displacement in Mode 2, which correspond to the white regions 44a, 44c in FIG. 4B. The notch locations identified with upward arrows 46b, 46d and downward arrows 46a, 46c will move one of the resonance frequencies of Mode 1 or Mode 2 respectively without impacting the resonance frequencies of the other mode.

Thus, adding or removing a mass to/from the disk at each of the upward and downward arrowed locations will move the resonance frequency in opposite directions.

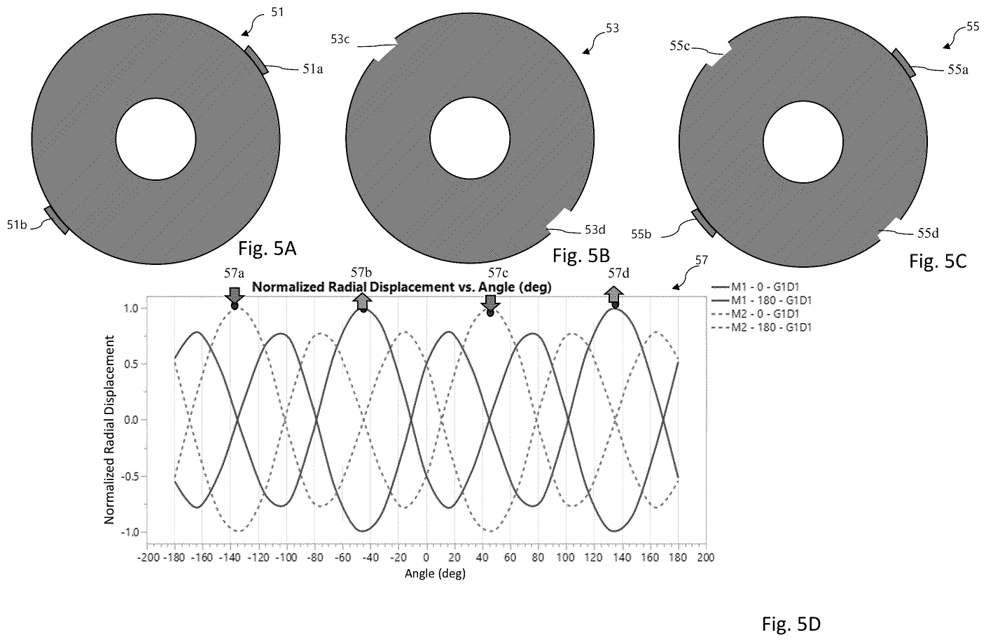

FIGS. 5A to 5D illustrate three examples of how to determine notch locations to impact the resonance frequencies of the disk according to one embodiment of the present disclosure.

As illustrated in FIG. 5A, two positive notches 51a, 51b are formed on the outer periphery of the disk 51 along 45° and −135° degrees. These notch locations correspond to the peak displacement points 57a, 57c in mode 2. As a result, the resonance frequency of Mode 2 decreases, while the resonance frequency of Mode 1 remains unaffected.

Referring to FIG. 5B, two negative notches 51a, 51b are formed on the outer periphery of the disk 51 along −45° and 135° degrees. These notch locations correspond to the peak displacement points 57a, 57c in mode 2. As a result, the resonance frequency of Mode 1 increases, while the resonance frequency of Mode 2 remains unaffected.

As shown in FIG. 5C, two positive notches 55a, 55b and two negative notches 55c, 55d are formed on the outer periphery of the disk 55 along 45° and −135° degrees, and −45° and 135°, respectively. These notch locations correspond to the peak displacement points 57a, 57c, and 57b, 57d, respectively. As a result, the resonance frequency of Mode 2 decreases, while the resonance frequency of Mode 1 increases.

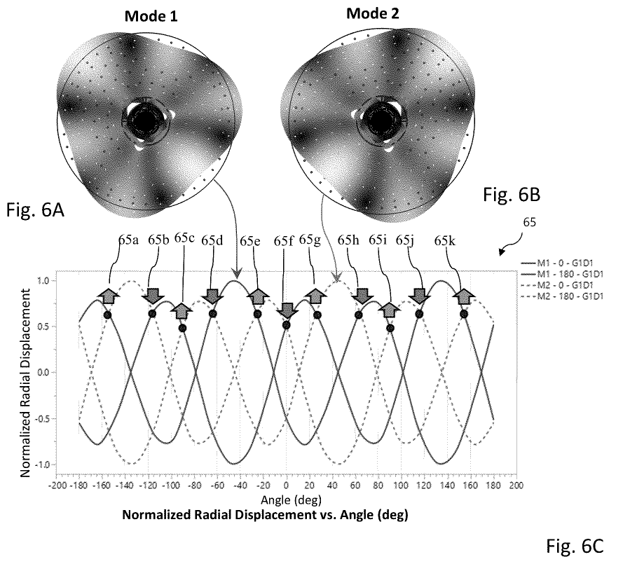

FIG. 6A to 6C show the diagrams to show how the notch locations impact stiffness couplings between the two modes according to another embodiment of the disclosure.

The notch locations may be identified so as to impact stiffness couplings between the two modes. In this embodiment, by adding or removing mass at areas where both modes have the same or substantially similar radial displacement amplitudes, mainly the stiffness coupling between the two modes will be impacted. Here the substantially similar radial displacement amplitudes refer to a radial displacement amplitude with a difference between the two normalized radial displacements within 10%.

Referring to FIG. 6C, the notch locations identified with upward arrows 65a, 65c, 65e, 65g, 65i, 65k, and downward arrows 65b, 65d, 65f, 65h, 65j, can be chosen to impact the stiffness couplings between the two modes in opposite directions.

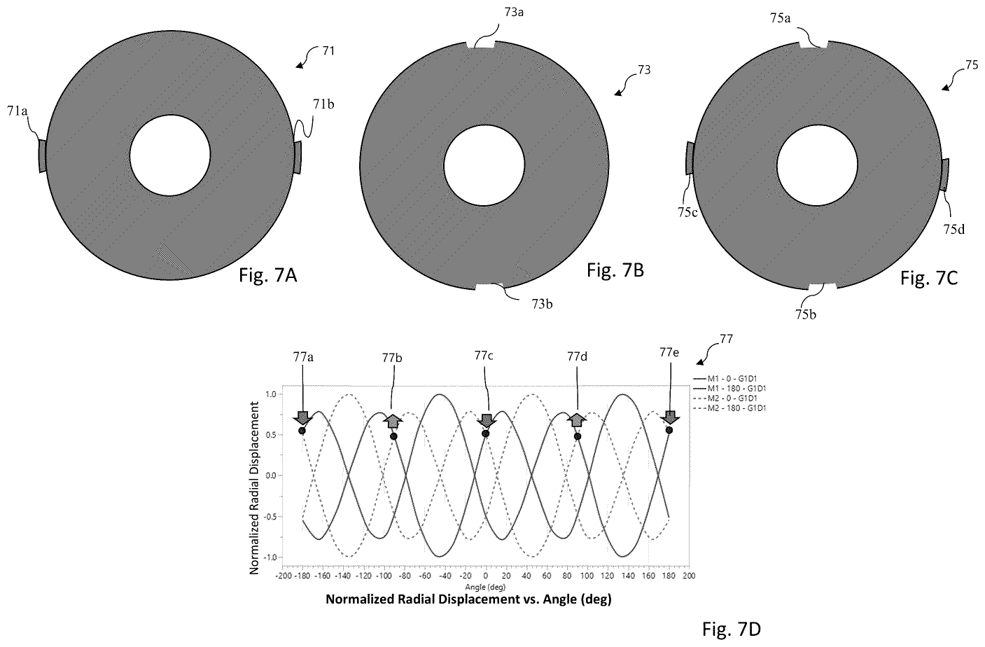

FIGS. 7A to 7D illustrate three examples of how to determine notch locations to impact stiffness couplings of the two modes according to one embedment of the present disclosure.

As illustrated in FIG. 7A, two positive notches 71a, 71b may be formed on the outer periphery of the disk 71 along 0° and 180° degrees. These notch locations correspond to the crossing points 77c, 77e in Mode 1 and Mode 2. As a result, the stiffness coupling k₁₂ increases.

Referring to FIG. 7B, two negative notches 73a, 73b may be formed on the outer periphery of the disk 72 along 90° and −90° degrees. These notch locations correspond to the crossing points 77b, 77d in Mode 1 and Mode 2. As a result, the stiffness coupling k₂₁ decreases.

As shown in FIG. 7C, two positive notches 75c, 75d and two negative notches 75a, 75b may be formed on the outer periphery of the disk 75 along 0° and 180° degrees, and 90° and −90° degrees. These notch locations correspond to the two crossing points 57a, 57c in mode 2. As a result, the stiffness coupling k₁₂ increases, while the stiffness coupling k₂₁ decreases.

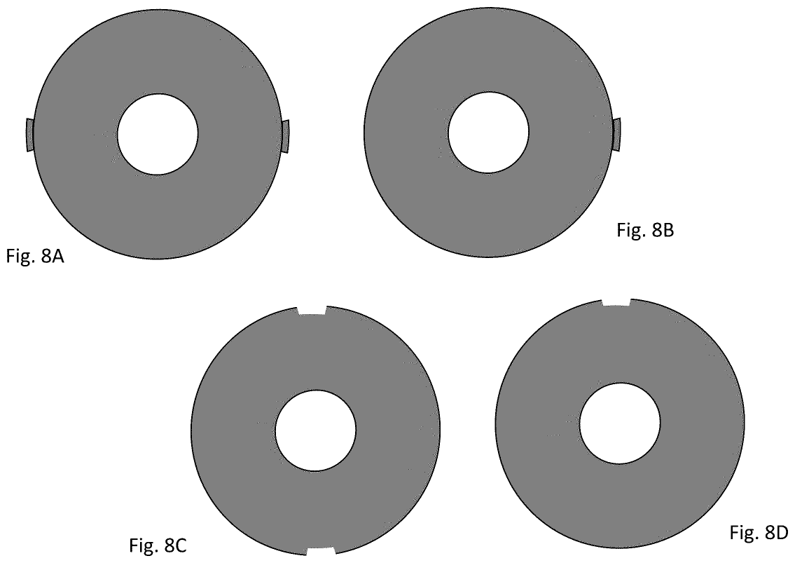

FIGS. 8A to 8F illustrate several examples on various shapes and arrangements of notches designed to impact the resonance frequencies.

The main goal of a notch is to add and remove a mass, and therefore the shape of a notch is not limited to any specific design. For example, the notch shape may be in the form of an arc, rectangle, square, half circle, triangle, etc.

In order to improve symmetry, it is preferred to add the same size notch on the opposing sides of the disk/ring as a pair as illustrated in FIGS. 8A and 8C, however, even one notch may suffice and still perform as expected as illustrated in FIGS. 8B and 8D.

FIGS. 8E and 8F illustrate other examples where one or more perforations in any shapes, including a circle, slit, etc. are formed close to the outer periphery of the disk, preferably, in the range of 20% of a radius of the disk from its outer periphery. The disk with perforations thereon would be less ideal as such design can impact other parameters but can be implemented to accomplish the same task as the notches on the outer periphery of the disk.

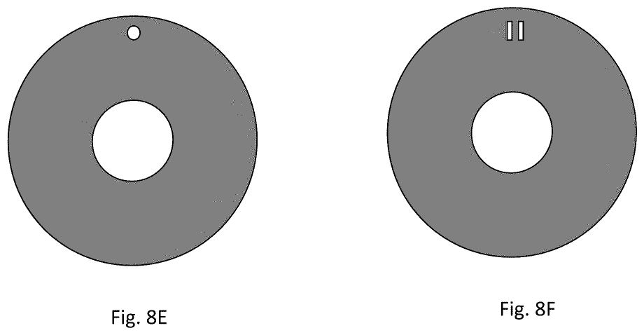

FIG. 9 illustrates the plots representing the electrostatic voltage (here called V_{Q}) pattern used to cancel quadrature across a wafer (or a disk). Depending on the imperfection, the two sets of electrodes have been used to cancel the quadrature, since the impacts of such electrodes are in opposite directions, they have been represented as positive and negative voltages in the plot.

The voltage range needed is very large and might be even larger than the range ASIC can provide limiting the yield, besides reducing this range further should help with charge pump design and power consumption.

Electrostatic voltage V_{Q} pattern can be used to calculate the actual stiffness coupling between the two modes of gyro which is induced during fabrication:

$$If {V}_{Q} \geq 0 then {k}_{12} = \frac{{ε}_{0} A}{2 {g}^{3}} ( {( {V}_{P} )}^{2} - {( {V}_{P} - {V}_{Q} )}^{2} ) \qquad ( Equation 3 )$$

$$If {V}_{Q} < 0 then {k}_{12} = \frac{{ε}_{0} A}{2 {g}^{3}} ( {( {V}_{P} - {V}_{Q} )}^{2} - {( {V}_{P} )}^{2} ) \qquad ( Equation 4 )$$

where V_{Q} is the electrostatic voltage applied to cancel quadrature, k₁₂ is stiffness coupling, V_{P} is the polarization voltage applied to the gyro, A is the electrode area and g is the gap size between the gyro and electrode.

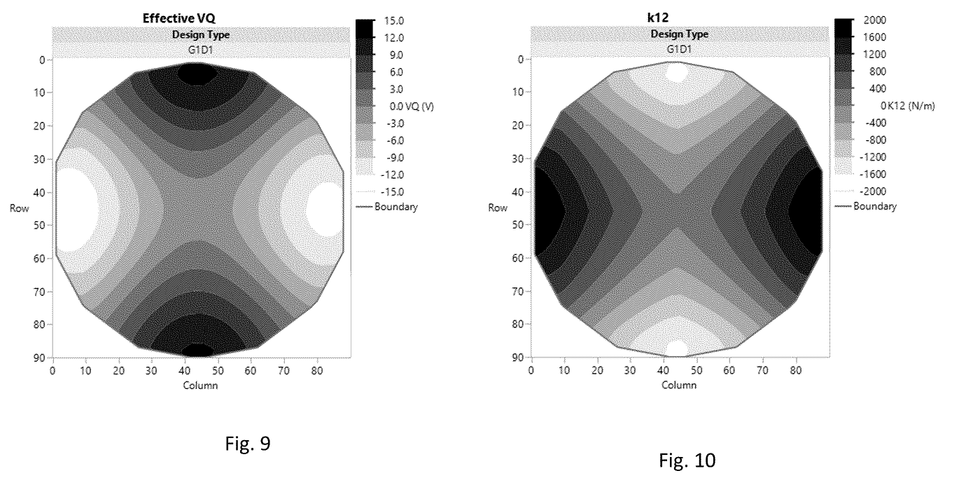

Based on Equations 3 and 4, V_{Q} can be converted to stiffness coupling k₁₂. FIG. 10 illustrates the stiffness coupling pattern that is converted from the electrostatic voltage V_{Q} of FIG. 9.

Next step is to add the notched gyro designs with non-zero k₁₂ in certain locations that can help reduce the k₁₂ distribution and quadrature across a wafer.

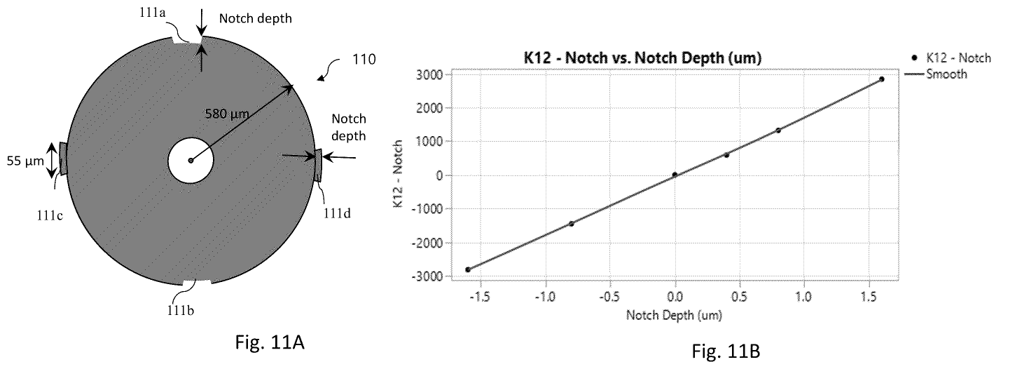

FIGS. 11A and 11B illustrate the experimental finite element analysis (FEA) results of k₁₂ values vs. notch sizes.

As illustrated in FIG. 11A, two positive notches 111c, 111d and two negative notches 111a, 111b are formed on the outer periphery of the disk 115 along 0° and 180° degrees, and 90° and −90° degrees. Here, the positive “notch depth” values represented an outward notch (a positive notch) along the X axis and an inward notch (a negative notch) along the Y axis. Negative “notch depth” values may represent the notches in opposite directions. These four notch depths are the same or substantially similar but have opposite signs along the two axes. The width of the four notches is set to be 55 μm.

FIG. 11B illustrates an FEA simulation result showing the relationship between notch depth and direction with the resulted k₁₂. As the notch depths increase, the stiffness coupling k₁₂ increases proportionally.

After considering the induced k₁₂ from fabrication across wafers and also the notch depth vs. k₁₂ from FEA simulations, multiple notch designs may be added across the wafer.

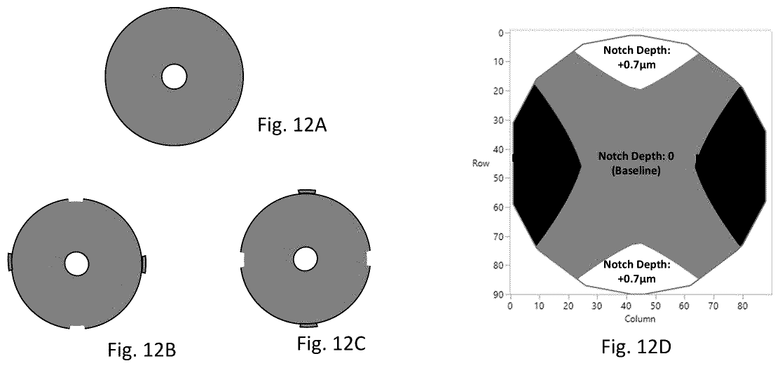

As an example, the baseline gyro design with no notch illustrated in FIG. 12A may be added with notched gyro design 1 with a notch depth of +0.7 μm illustrated in FIG. 12B and notched gyro design 2 with a notch depth of −0.7 μm illustrated in FIG. 12C, which results in the combined gyro design illustrated in FIG. 12D.

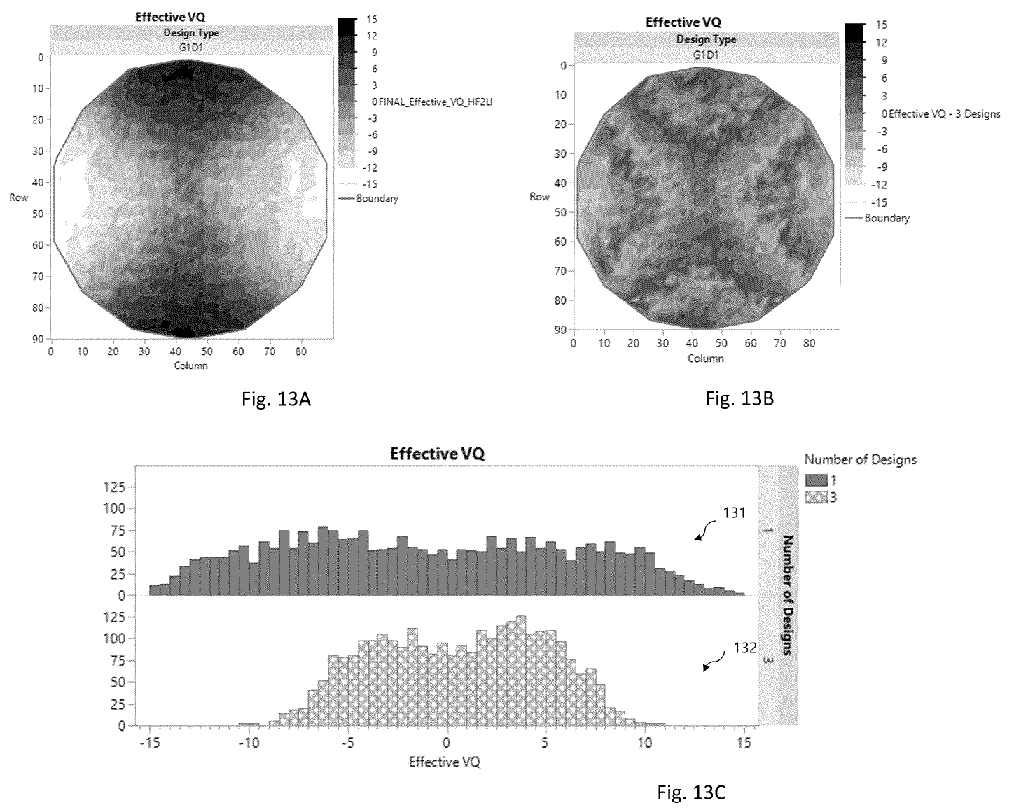

FIG. 13A illustrates the experimental effective electrostatic voltage V_{Q} of a baseline design, and FIG. 13B illustrates the effective electrostatic voltage V_{Q} of the combined three designs. FIG. 13C illustrates the histogram distribution comparison of V_{Q} between the baseline design and the combined three designs.

After implementing the three designs (baseline design and the two notched designs) into one wafer, the effective V_{Q} pattern 132 of the three designs is compared with the effective V_{Q} pattern 131 one design (baseline) case, showing the reduction in the V_{Q} range. The number of designs can further increase to further reduce the V_{Q}/quadrature range.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A gyroscope comprising:
a vibratory plate with at least one notch, wherein each notch is a positive notch that is formed by adding a mass to the vibratory plate, or a negative notch that is formed by removing a mass from the vibratory plate; and
an anchor configured to support the vibratory plate.

2. The gyroscope according to claim 1, wherein
at least one notch is formed on an outer periphery of the vibratory plate.

3. The gyroscope according to claim 1, wherein
at least one notch comprises two positive notches located in opposite sides of the vibratory plate.

4. The gyroscope according to claim 1, wherein
at least one notch comprises two negative notches located in opposite sides of the vibratory plate.

5. The gyroscope according to claim 1, wherein
at least one notch comprises two positive notches located in opposite sides of the vibratory plate, and two negative notches located in opposite sides of the vibratory plate.

6. The gyroscope according to claim 1, wherein
each location of the at least one notch is identified so as to substantially impact a stiffness of one of the first resonance mode or the second resonance mode.

7. The gyroscope according to claim 1, wherein
each location of the at least one notch is determined at a position that has a larger displacement in one resonance mode and that has a smaller displacement in another resonance mode.

8. The gyroscope according to claim 1, wherein
each location of the at least one notch is determined at a position that has a substantially maximum displacement in a first resonance mode and that has a substantially zero displacement in a second resonance mode.

9. The gyroscope according to claim 8, wherein
a resonance frequency of the first mode increases, while a resonance frequency of the second resonance mode remains relatively unaffected compared to the increased resonance frequency of the second mode.

10. The gyroscope according to claim 1, wherein
each location of the at least one notch is determined at a position that has a substantially zero displacement in a first resonance mode and that has the substantially maximum displacement in the second resonance mode.

11. The gyroscope according to claim 10, wherein
a resonance frequency of the second mode decreases, while a resonance frequency of the first resonance mode remains relatively unaffected compared to the decreased resonance frequency of the second mode.

12. The gyroscope according to claim 10, wherein
at least one notch comprises two positive notches, wherein a first positive notch is located at a position with a substantially maximum displacement in the first resonance mode, and a second positive notch is located at a position with a substantially maximum displacement in the second resonance mode, wherein the first and second notches are in opposite sides of the vibratory plate.

13. The gyroscope according to claim 10, wherein
at least one notch comprises two negative notches, wherein a first negative notch is located at a position with a substantially maximum displacement in the first resonance mode, and a second negative notch is located at a position with a substantially maximum displacement in the second resonance mode, wherein the first and second negative notches are in opposite sides of the vibratory plate.

14. The gyroscope according to claim 10, wherein
at least one notch comprises two positive notches and two negative notches, wherein the two positive notches are located in opposite sides at respective positions with a substantially maximum displacement in the first resonance mode, and the two negative notches are located in opposite sides at respective positions with a substantially maximum displacement in the second resonance mode.

15. The gyroscope according to claim 10, wherein
each location of the at least one notch is identified so as to impact a stiffness coupling between the first resonance mode and a second resonance mode.

16. The gyroscope according to claim 1, wherein
each location of the at least one notch is determined at a position that has a substantially same displacement in the first and second resonance modes.

17. The gyroscope according to claim 16, wherein
a stiffness coupling between the first and second resonance mode increases or decreases, depending on an angle of the position.

18. The gyroscope according to claim 16, wherein
at least one notch comprises two positive notches, wherein a first positive notch is located at a position with the substantially same displacement in one resonance mode, and a second positive notch is located at a position with the substantially same displacement in another resonance mode, wherein the first and second positive notches are in opposite sides of the vibratory plate.

19. The gyroscope according to claim 16, wherein
at least one notch comprises two negative notches, wherein a first negative notch is located at a position with the substantially same displacement in the first and second resonance modes, and a second negative notch is located at a position with the substantially same displacement in the first and second resonance modes, wherein the first and second negative notches are in opposite sides of the vibratory plate.

20. The gyroscope according to claim 16, wherein
the at least one notch comprises two positive notches and two negative notches, wherein the two positive notches are located in opposite sides at respective positions with the substantially same displacement in the first and second resonance modes, and two negative notches are located in opposite sides at respective positions with the substantially same displacement in the first and second resonance modes.
